(19) United States
(12) Patent Application Publication
(10) Pub. No.: US 2022/0392193 A1
(43) Pub. Date: Dec. 8, 2022

(54) THREE-DIMENSIONAL POINT CLOUD LABEL LEARNING DEVICE, THREE- DIMENSIONAL POINT CLOUD LABEL ESTIMATION DEVICE, METHOD, AND PROGRAM

(71) Applicant: NIPPON TELEGRAPH AND TELEPHONE CORPORATION, Tokyo (JP)

(72) Inventors: Yasuhiro YAO, Tokyo (JP); Hitoshi NIIGAKI, Tokyo (JP); Shingo ANDO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 17/775,837

(22) PCT Filed: Nov. 11, 2019
(86) PCT No.: PCT/JP2019/044138

§ 371 Date: May 10, 2022

(51) Int. Cl. G06V 10/762; G06V 10/77; G06V 10/82

(52) U.S. Cl. CPC G06V 10/762; G06V 10/7715; G06V 10/82

(57) ABSTRACT

A clustering unit (101) divides an input three-dimensional point cloud into a plurality of clusters and outputs cluster data, a surrounding point sampling unit (102) extracts, for each of the plurality of clusters, a surrounding three-dimensional point cloud present within a predetermined distance of the cluster based on the three-dimensional point cloud and the cluster data, a learning unit (103) receives, as inputs, extended cluster data including information on a three-dimensional point cloud included in each cluster obtained by the division and information on the extracted surrounding three-dimensional point cloud and a correct answer label indicative of an object to which the three-dimensional point cloud included in each cluster belongs, and learns a parameter of a DNN for estimating a label of each cluster from the extended cluster data, and an estimation unit (104) inputs the extended cluster data related to the cluster of which the label is unknown to the DNN of which the parameter is trained to estimate the label of each cluster.

### TECHNICAL FIELD

The disclosed technique relates to a three-dimensional point cloud label learning device, a three-dimensional point cloud label estimating device, a three-dimensional point cloud label learning method, a three-dimensional point cloud label estimating method, and a three-dimensional point cloud label learning program.

### BACKGROUND ART

Data having three-dimensional position coordinates (x, y, z) and any number of pieces of attribute information is referred to as a three-dimensional point. Data constituted by a group of such three-dimensional points is referred to as a three-dimensional point cloud. The three-dimensional point cloud is data indicative of geometric information of an object, and can be acquired by measurement by a distance sensor and three-dimensional reconstruction from an image. The attribute information of the three-dimensional point is information other than position coordinates obtained when measurement of the three-dimensional point cloud is performed, and examples of the attribute information thereof include an intensity value indicative of reflection intensity at each point, and RGB values indicative of color information.

There is proposed a technique in which, by dividing (clustering) the three-dimensional point cloud into small areas (clusters) and identifying an object represented by the three-dimensional point cloud for each cluster, a label indicative of the identified object is given to each cluster.

In particular, in the case where a target object to be identified is an artificial object, the artificial object often has a structure in which a given cross-sectional shape is stretched. Accordingly, as described in NPL 1, it is possible to perform clustering of the artificial object with high accuracy by using a clustering method in which the artificial object is divided into clusters each having a shape having a constant cross-sectional shape (sweep shape). In addition, PTL 1 describes a technique in which the three-dimensional point cloud is divided into clusters each having the sweep shape by the method described in NPL 1, a histogram feature amount is derived for each cluster, and a label is given to each cluster based on the derived feature amount.

### CITATION LIST

### Patent Literature

[PTL 1] Japanese Patent Application Publication No. 2019-3527

### Non Patent Literature

[NPL 1] H. Niigaki, J. Shimamura and A. Kojima, “Segmentation of 3D Lidar Points using Extruded Surface of Cross Section”, 2015 International Conference on 3D Vision, Lyon, 2015, pp. 109-117.

### SUMMARY OF THE INVENTION

### Technical Problem

In the technique described in PTL 1 described above, the point cloud is identified by the histogram feature amount designed by man. In recent years, in many field, it is reported that identification performance of a feature amount obtained by deep learning which uses a deep neural network (DNN) is higher than that of the feature amount designed by man. In the technique of PTL 1, the feature mount obtained by the deep learning is not used, and hence accuracy in the estimation of the label given to the three-dimensional point cloud is supposed to be limited.

The disclosed technique has been made in view of the above points, and an object thereof is to provide a three-dimensional point cloud label learning device, a three-dimensional point cloud label estimating device, a three-dimensional point cloud label learning method, a three-dimensional point cloud label estimating method, and a three-dimensional point cloud label learning program which are capable of performing giving of a label to a three-dimensional point cloud representing a sweep shape structure with high accuracy.

### Means for Solving the Problem

A first aspect of the present disclosure is a three-dimensional point cloud label learning device including: a clustering unit which divides an input three-dimensional point cloud into a plurality of clusters; a surrounding point sampling unit which extracts, for each of the plurality of clusters, a surrounding three-dimensional point cloud present within a predetermined distance of the cluster based on the three-dimensional point cloud and a result of cluster by the clustering unit; and a learning unit which receives, as inputs, cluster information including information on a three-dimensional point cloud included in each cluster obtained by the division by the clustering unit and information on the surrounding three-dimensional point cloud extracted by the surrounding point sampling unit, and a label indicative of an object to which the three-dimensional point cloud included in each cluster belongs, and learns a parameter of a deep neural net (DNN) for estimating the label of each cluster from the cluster information.

A second aspect of the present disclosure is a three-dimensional point cloud label estimating device including: a clustering unit which divides an input three-dimensional point cloud into a plurality of clusters; a surrounding point sampling unit which extracts, for each of the plurality of clusters, a surrounding three-dimensional point cloud present within a predetermined distance of the cluster based on the three-dimensional point cloud and a result of cluster by the clustering unit; and an estimation unit which inputs cluster information related to the cluster of which a label is unknown to a deep neural net (DNN) for estimating the label of each cluster from the cluster information which is trained by using, as inputs, the cluster information including information on a three-dimensional point cloud included in each cluster obtained by the division by the clustering unit and information on the surrounding three-dimensional point cloud extracted by the surrounding point sampling unit, and the label indicative of an object to which the three-dimensional point cloud included in each cluster belongs to estimate the label of the cluster of which the label is unknown.

A third aspect of the present disclosure is a three-dimensional point cloud label learning method including: causing a clustering unit to divide an input three-dimensional point cloud into a plurality of clusters; causing a surrounding point sampling unit to extract, for each of the plurality of clusters, a surrounding three-dimensional point cloud present within a predetermined distance of the cluster based on the three-dimensional point cloud and a result of cluster by the clustering unit; and causing a learning unit to receive, as inputs, cluster information including information on a three-dimensional point cloud included in each cluster obtained by the division by the clustering unit and information on the surrounding three-dimensional point cloud extracted by the surrounding point sampling unit, and a label indicative of an object to which the three-dimensional point cloud included in each cluster belongs, and learn a parameter of a deep neural net (DNN) for estimating the label of each cluster from the cluster information.

A fourth aspect of the present disclosure is a three-dimensional point cloud label estimating method including: causing a clustering unit to divide an input three-dimensional point cloud into a plurality of clusters; causing a surrounding point sampling unit to extract, for each of the plurality of clusters, a surrounding three-dimensional point cloud present within a predetermined distance of the cluster based on the three-dimensional point cloud and a result of cluster by the clustering unit; and causing an estimation unit to input cluster information related to the cluster of which a label is unknown to a deep neural net (DNN) for estimating the label of each cluster from the cluster information which is trained by using, as inputs, the cluster information including information on a three-dimensional point cloud included in each cluster obtained by the division by the clustering unit and information on the surrounding three-dimensional point cloud extracted by the surrounding point sampling unit, and the label indicative of an object to which the three-dimensional point cloud included in each cluster belongs to estimate the label of the cluster of which the label is unknown.

A fifth aspect of the present disclosure is a three-dimensional point cloud label learning program for causing a computer to function as: a clustering unit which divides an input three-dimensional point cloud into a plurality of clusters; a surrounding point sampling unit which extracts, for each of the plurality of clusters, a surrounding three-dimensional point cloud present within a predetermined distance of the cluster based on the three-dimensional point cloud and a result of cluster by the clustering unit; and a learning unit which receives, as inputs, cluster information including information on a three-dimensional point cloud included in each cluster obtained by the division by the clustering unit and information on the surrounding three-dimensional point cloud extracted by the surrounding point sampling unit, and a label indicative of an object to which the three-dimensional point cloud included in each cluster belongs, and learns a parameter of a deep neural net (DNN) for estimating the label of each cluster from the cluster information.

### Effects of the Invention

According to the disclosed technique, it is possible to perform giving of the label to the three-dimensional point cloud representing the sweep shape structure with high accuracy.

### BRIEF DESCRIPTION OF DRAWINGS

FIG. 1 is a block diagram showing hardware elements of a three-dimensional point cloud label learning-estimating device according to an embodiment.

FIG. 2 is a block diagram showing examples of functional elements of the three-dimensional point cloud label learning-estimating device according to the embodiment.

FIG. 3 is a block diagram showing examples of functional elements which function at the time of learning.

FIG. 4 is a block diagram showing examples of functional elements which function at the time of estimation.

FIG. 5 is a view showing an example of a result of clustering.

FIG. 6 is a view for explaining an effect of use of a cluster surrounding point.

FIG. 7 is a view showing an example of a three-dimensional point cloud which is represented by a shade which differs from one correct answer label to another.

FIG. 8 is a view showing an example of a PointNet partial structure of a DNN.

FIG. 9 is a view showing another example of the PointNet partial structure of the DNN.

FIG. 10 is a view showing an example of the three-dimensional point cloud colored by using a result of estimation of a label of a cable.

FIG. 11 is a flowchart showing the procedure of learning processing.

FIG. 12 is a flowchart showing the procedure of estimation processing.

### DESCRIPTION OF EMBODIMENTS

Hereinbelow, an example of an embodiment of the disclosed technique will be described with reference to the drawings. Note that, in the individual drawings, constituent elements and portions which are identical or equivalent to each other are designated by the same reference numerals. In addition, there are cases where dimension ratios in the drawings are exaggerated for the convenience of description, and are different from actual dimension ratios.

<Outline of Present Embodiment>

A three-dimensional point cloud label learning-estimating device according to the present embodiment receives, as an input, a three-dimensional point cloud which is data constituted by a group of three-dimensional points each having three-dimensional position coordinates (x, y, z) and any number of pieces of attribute information. Subsequently, the three-dimensional point cloud label learning-estimating device according to the present embodiment estimates a label of each three-dimensional point from the position coordinates and the attribute information of each three-dimensional point included in the three-dimensional point cloud. In addition, the three-dimensional point cloud label learning-estimating device according to the present embodiment performs learning for implementing a label estimation function by the three-dimensional point cloud label learning-estimating device.

Herein, examples of the attribute information of the three-dimensional point include an intensity value indicative of reflection intensity at each point and RGB values indicative of color information, but the attribute information is not limited thereto. In addition, the label indicates what object each three-dimensional point belongs to. For example, in the case of the three-dimensional point cloud obtained by measuring an urban area, examples of the label include labels indicative of a building, a road, a tree, and a sign. The type of the label can be arbitrarily set by a user, and is not particularly limited in the present embodiment.

<Elements of Three-Dimensional Point Cloud Label Learning-Estimating Device>

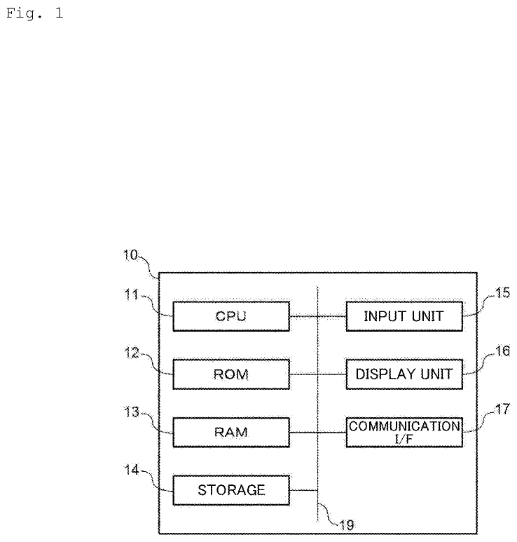

FIG. 1 is a block diagram showing hardware elements of a three-dimensional point cloud label learning-estimating device 10.

As shown in FIG. 1, the three-dimensional point cloud label learning-estimating device 10 has a CPU (Central Processing Unit) 11, a ROM (Read Only Memory) 12, a RAM (Random Access Memory) 13, a storage 14, an input unit 15, a display unit 16, and a communication I/F (Interface) 17. The individual elements are connected to each other so as to be able to communicate with each other via a bus 19.

The CPU 11 is a central processing unit, and executes various programs and controls each unit. That is, the CPU 11 reads a program from the ROM 12 or the storage 14, and executes the program by using the RAM 13 as a work area. The CPU 11 performs the control of each element mentioned above and various arithmetic processing according to the program stored in the ROM 12 or the storage 14. In the present embodiment, in the ROM 12 or the storage 14, a three-dimensional point cloud label learning program for executing learning processing described later, and a three-dimensional point cloud label estimation program for executing estimation processing described later are stored.

The ROM 12 stores various program and various pieces of data. The RAM 13, which serves as a work area, stores a program and data temporarily. The storage 14 is constituted by a storage device such as an HDD (Hard Disk Drive) or an SSD (Solid State Drive), and stores various programs including an operating system and various pieces of data.

The input unit 15 includes a pointing device such as a mouse, and a keyboard, and is used to perform various inputs.

The display unit 16 is, e.g., a liquid crystal display, and displays various pieces of information. The display unit 16 may function as the input unit 15 by using a touch panel system.

The communication I/F 17 is an interface for communicating with other equipment, and standards such as, e.g., Ethernet (registered trademark), FDDI, and Wi-Fi (registered trademark) are used.

Note that the three-dimensional point cloud label learning-estimating device 10 may include a GPU (Graphics Processing Unit).

Next, a description will be given of functional elements of the three-dimensional point cloud label learning-estimating device 10.

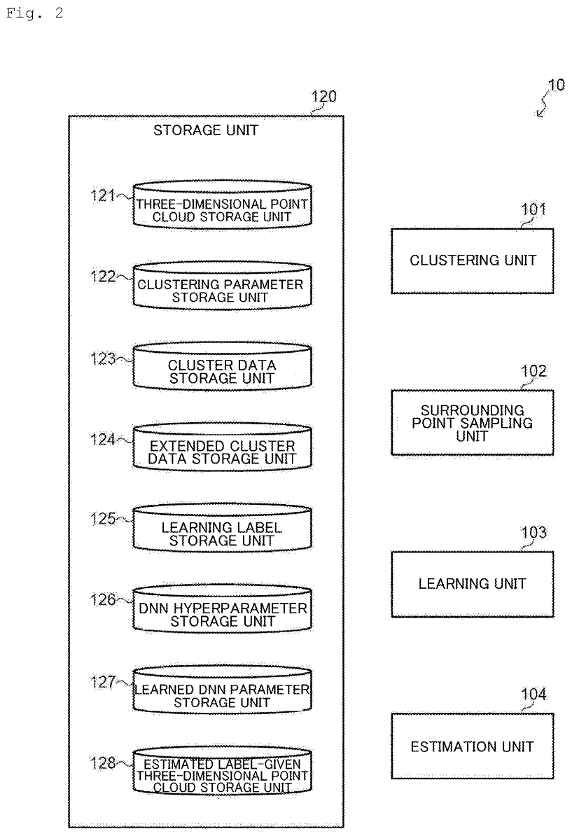

FIG. 2 is a block diagram showing examples of the functional elements of the three-dimensional point cloud label learning-estimating device 10.

As shown in FIG. 2, the three-dimensional point cloud label learning-estimating device 10 has, as the functional elements, a clustering unit 101, a surrounding point sampling unit 102, a learning unit 103, and an estimation unit 104. The CPU 11 reads the three-dimensional point cloud label learning program and the three-dimensional point cloud label estimation program stored in the ROM 12 or the storage 14, loads the programs into the RAM 13, and executes the programs, and each functional element is thereby implemented.

In addition, in a predetermined storage area of the three-dimensional point cloud label learning-estimating device 10, a storage unit 120 is provided. The storage unit 120 further includes a three-dimensional point cloud storage unit 121, a clustering parameter storage unit 122, a cluster data storage unit 123, an extended cluster data storage unit 124, a learning label storage unit 125, a DNN (Deep Neural Network) hyperparameter storage unit 126, a learned DNN parameter storage unit 127, and an estimated label-given three-dimensional point cloud storage unit 128.

The three-dimensional point cloud label learning-estimating device 10 functions as a three-dimensional point cloud label learning device at the time of learning of a parameter of the DNN, and functions as a three-dimensional point cloud label estimating device at the time of estimation of the label of the three-dimensional point cloud.

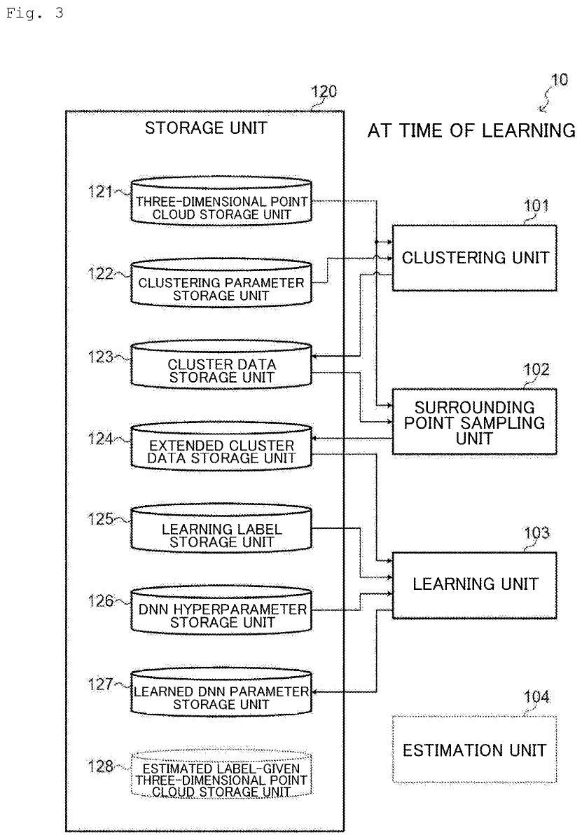

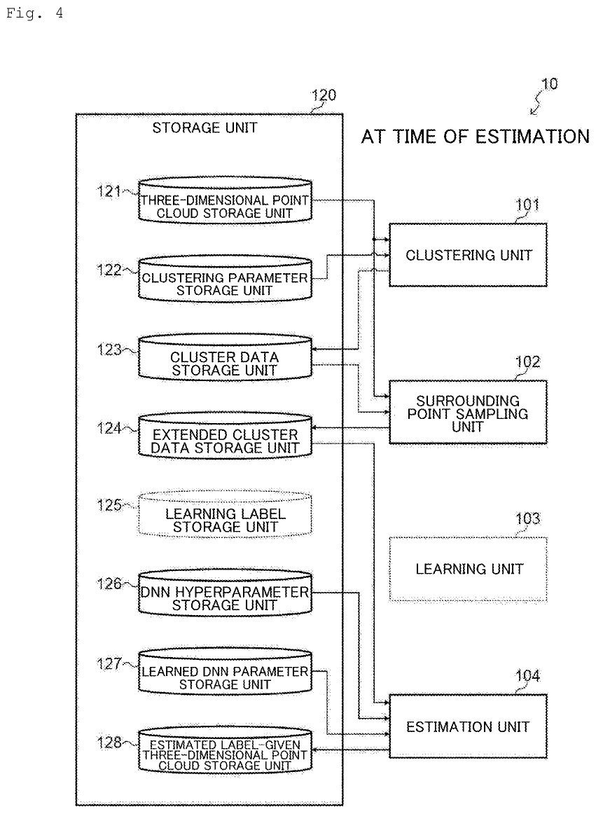

At the time of the learning, as shown in FIG. 3, with the elements other than the estimation unit 104 and the estimated label-given three-dimensional point cloud storage unit 128, the three-dimensional point cloud label learning-estimating device 10 functions as the three-dimensional point cloud label learning device. In addition, at the time of the estimation, as shown in FIG. 4, with the elements other than the learning unit 103 and the learning label storage unit 125, the three-dimensional point cloud label learning-estimating device 10 functions as the three-dimensional point cloud label estimating device. Hereinbelow, each functional element and information stored in each storage unit will be described in detail.

At the time of the learning, the clustering unit 101 acquires information on, among the three-dimensional point clouds input to the three-dimensional point cloud label learning-estimating device 10, the three-dimensional point cloud in which the label is given to each three-dimensional point (hereafter referred to as “input three-dimensional point cloud”) from the three-dimensional point cloud storage unit 121. In addition, the clustering unit 101 acquires a clustering parameter which is a parameter dependent on a clustering method to be used from the clustering parameter storage unit 122.

The clustering unit 101 receives, as inputs, the acquired information on the input three-dimensional point cloud and the acquired clustering parameter, and divides (clustering) the input three-dimensional point cloud into a plurality of areas (clusters). The clustering unit 101 outputs, for each cluster obtained by the division, cluster data including the position coordinates and the attribute information of each three-dimensional point included in the cluster and attribute information obtained by clustering processing, and stores the cluster data in the cluster data storage unit 123. The attribute information of the three-dimensional point includes attribute information inherent in the three-dimensional point (an intensity value, RGB values, or the like), geometric attribute information, and the like.

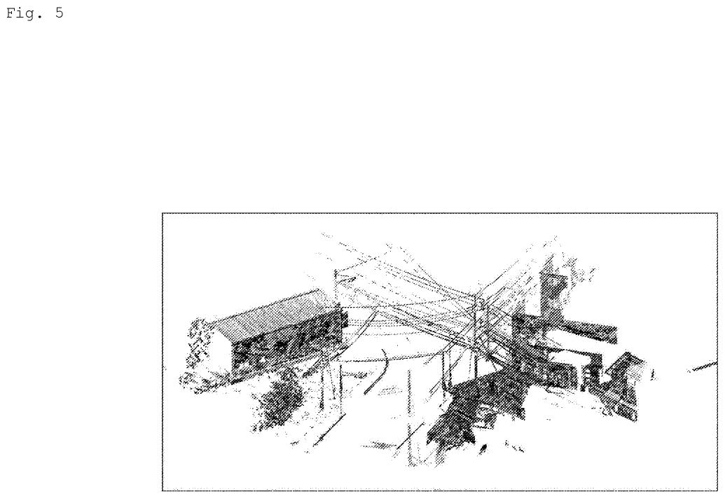

Specifically, as an example, the clustering unit 101 performs clustering of the input three-dimensional point cloud by processing identical to that of a clustering unit of PTL 1. In this case, the clustering unit 101 outputs a normal direction and an extrusion direction as the geometric attribute information of each three-dimensional point included in the cluster. Note that each of the normal direction and the extrusion direction is a three-dimensional vector of which the square norm is 1. In order to prevent loss of significance in processing in a calculator, the position coordinates of the three-dimensional point included in each cluster are held as a difference between center coordinates of the cluster and a cluster center of each three-dimensional point. FIG. 5 shows an example of a result of clustering by the present method. In the example in FIG. 5, each cluster is represented by using a color matching (same shade) area.

For example, the clustering unit 101 can output the cluster data including the following information for each cluster.

(D1) center: position coordinates of a cluster center obtained as an average value of position coordinates (x, y, z) of each three-dimensional point included in a cluster.

(D2) positions: position coordinates (x, y, z) of each three-dimensional point included in the cluster with center used as the original.

(D3) point_attributes: scalar attribute information such as an intensity value and RGB values inherent in each three-dimensional point included in the cluster. Let a denote the number of attributes included in point_attributes.

(D4) cluster_attributes: scalar attribute information of each cluster obtained by clustering processing. For example, in the case where a running path of a vehicle of which the three-dimensional point cloud is measured is obtained, a distance on an xy plane (distance_xy) and a distance in a z direction (distance_z) from a nearest neighbor point in the running path at the position of center serve as the attribute information. In addition, the number of points included in the cluster (num_of_points) serves as the attribute information. The attribute information also includes any feature amount obtained for other clusters. Let b denote the number of attributes included in cluster_attributes.

(D5) 3d_attributes: three-dimensional attribute information of each three-dimensional point which is geometric information. The normal direction and the extrusion direction are included in the attribute information. In addition, attribute information such as an eigenvector to the cluster may also be included. Let c denote the number of attributes included in 3d_attributes.

(D6) point_indices: index information for indicating the position of the three-dimensional point included in the cluster in an original input file (input three-dimensional point cloud).

At the time of the estimation, the clustering unit 101 acquires information on the three-dimensional point cloud of which the label is unknown (hereafter referred to as “target three-dimensional point cloud”) from the three-dimensional point cloud storage unit 121, and performs the clustering processing similarly to the time of the learning.

At the time of the learning, the surrounding point sampling unit 102 extracts, for each of the plurality of clusters, a surrounding three-dimensional point cloud which is present within a predetermined distance of the cluster based on the input three-dimensional point cloud and a result of cluster by the clustering unit 101.

Specifically, the surrounding point sampling unit 102 acquires the input three-dimensional point cloud from the three-dimensional point cloud storage unit 121, and acquires the cluster data from the cluster data storage unit 123. The surrounding point sampling unit 102 extracts the surrounding three-dimensional point by using a preset distance r and searching the input three-dimensional point cloud for the three-dimensional point which is present within the distance r of the three-dimensional point included in the cluster and is not included in the cluster.

Hereinbelow, the three-dimensional point included in the cluster is referred to as “cluster internal point”, and the three-dimensional point around the cluster which is extracted by the surrounding point sampling unit 102 is referred to as “cluster surrounding point”.

The surrounding point sampling unit 102 outputs extended cluster data in which information on each extracted cluster surrounding point is added to the acquired cluster data, and stores the extended cluster data in the extended cluster data storage unit 124. That is, the extended cluster data includes, for each cluster, the position coordinates of the cluster internal point, the attribute information inherent in the cluster internal point, the geometric attribute information, and the attribute information obtained by the clustering processing. Further, the extended cluster data includes the position coordinates of the cluster surrounding point, the attribute information inherent in the cluster surrounding point, and the geometric attribute information.

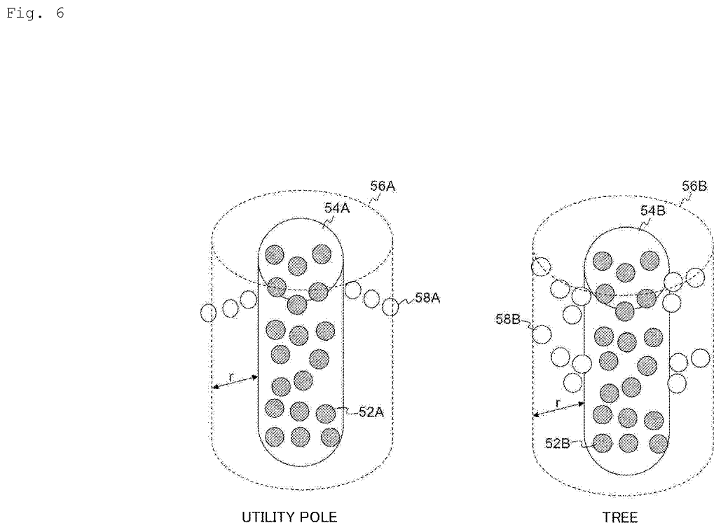

The purpose of extracting the cluster surrounding point is to perform label estimation of the cluster by using geometric features of the cluster surrounding point. An effect of use of the cluster surrounding point will be described by using examples of a utility pole and a tree shown in FIG. 6. As shown in FIG. 6, when the utility pole and the tree are subjected to clustering, there are cases where a pole and a trunk are extracted as cylindrical clusters. In the case where the shapes of the clusters are similar to each other, it is difficult to identify objects represented by clusters 54A and 54B only with cluster internal points 52A and 52B.

To cope with this, the cluster surrounding points are utilized. When the three-dimensional points present in an area 56A positioned within the distance r of the cluster 54A of the utility pole are extracted, it is conceivable that three-dimensional points 58A representing a facility belonging to the pole such as an electric wire will be extracted. On the other hand, when the three-dimensional points present in an area 56B positioned within the distance r of the cluster 54B of the trunk of the tree are extracted, it is conceivable that three-dimensional points 58B representing branches will be extracted. In this case, a cluster surrounding point cloud of the cluster 54A of the utility pole and a cluster surrounding point cloud of the cluster 54B of the trunk of the tree have totally different geographic shapes. Accordingly, the cluster surrounding point cloud serves as information useful for performing the learning and the estimation described later.

At the time of the estimation, the surrounding point sampling unit 102 acquires the target three-dimensional point cloud from the three-dimensional point cloud storage unit 121, and extracts the cluster surrounding point for each cluster similarly to the time of the learning.

The learning unit 103 receives, as inputs, the extended cluster data and a correct answer label of an object represented by the cluster internal point, and learns a DNN parameter for estimating the label of each cluster from the extended cluster data.

Specifically, the learning unit 103 acquires the extended cluster data from the extended cluster data storage unit 124, and acquires a learning label from the learning label storage unit 125.

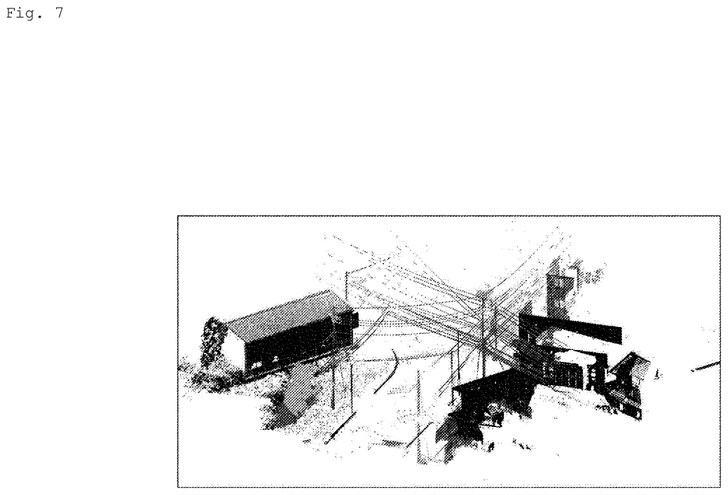

The learning label stored in the learning label storage unit 125 corresponds to an initial three-dimensional point cloud stored in the three-dimensional point cloud storage unit 121 and is the label of each three-dimensional point, and hence the learning unit 103 derives the correct answer label of each cluster from the learning label. For example, the learning unit 103 associates the cluster internal point with the learning label which is correct answer data of the label by using information of (D6) point_indices included in the extended cluster data. In the case where, with regard to each cluster, X % or more of the cluster internal points in the cluster have the same label Y, the learning unit 103 derives Y as the correct answer label of the cluster. Note that X is a predetermined percentage, and may be set to, e.g., 80. FIG. 7 shows an example of the three-dimensional point cloud represented by a shade which differs from one derived correct answer label to another.

In addition, the learning unit 103 acquires a DNN hyperparameter from the DNN hyperparameter storage unit 126. The DNN hyperparameter denotes a parameter set which includes information indicated by the following (1) to (8), and specifies a learning method of the DNN. Note that words in parentheses indicate variable names.

(1) the number of input points (N, M): specifies the maximum number of cluster internal points per cluster and the maximum number of cluster surrounding points per cluster which are received as inputs of the DNN.

(2) optimization algorithm (optimizer): specifies an optimization method of the DNN (Gradient Decent, Moment, Adam, or the like).

(3) learning efficiency (learning_rate): the efficiency of initial DNN parameter update.

(4) learning efficiency decay rate (decay_rate): a value used when decay of the learning efficiency is calculated.

(5) learning efficiency decay steps (decay_steps): a value used when the decay of the learning efficiency is calculated.

(6) the number of learning epochs (max_epoch): the number of epochs for performing the update of the DNN parameter.

(7) batch size (batch_size): the number of pieces of data (cluster) used when the DNN parameter is updated once.

(8) the number of labels (k): the total number of labels including “others”.

Note that the above DNN hyperparameters are parameters which are not limited to the present embodiment and are typically specified at the time of learning of the DNN except the number of input points (N, M) and the number of labels (k). In the present embodiment, the optimization method of the DNN is not limited, and the present parameter set is replaced with a combination of other known parameters.

The learning unit 103 can use, e.g., the DNN having a partial structure based on PointNet described in Reference Literature 1 shown below. The partial structure includes a T-Net layer, a pointwise mlp layer, and a global feature extraction layer. The T-Net layer receives, as inputs, three-dimensional information of (D2) positions and (D5) 3d_attributes, and performs a three-dimensional geometric transformation on received coordinates and vectors. The pointwise mlp layer receives an output of the T-Net layer and (D3) point_attributes as inputs and applies a multilayer perceptron (mlp) to each three-dimensional point to thereby extract the feature amount of each three-dimensional point. The global feature extraction layer integrates the feature amounts of the individual three-dimensional points to extract the feature amount of the entire input three-dimensional point cloud by feature extraction processing.

Reference Literature 1: Qi, Charles R., et al. “Pointnet: Deep learning on point sets for 3d classification and segmentation”, Proceedings of the IEEE Conference on Computer Vision and Pattern Recognition, 2017.

In the present embodiment, when the feature amount is extracted from the information on the cluster internal point cloud and the cluster surrounding point cloud, it is possible to adopt a configuration A in which one PointNet partial structure described above is used, and a configuration B in which two PointNet partial structures are used.

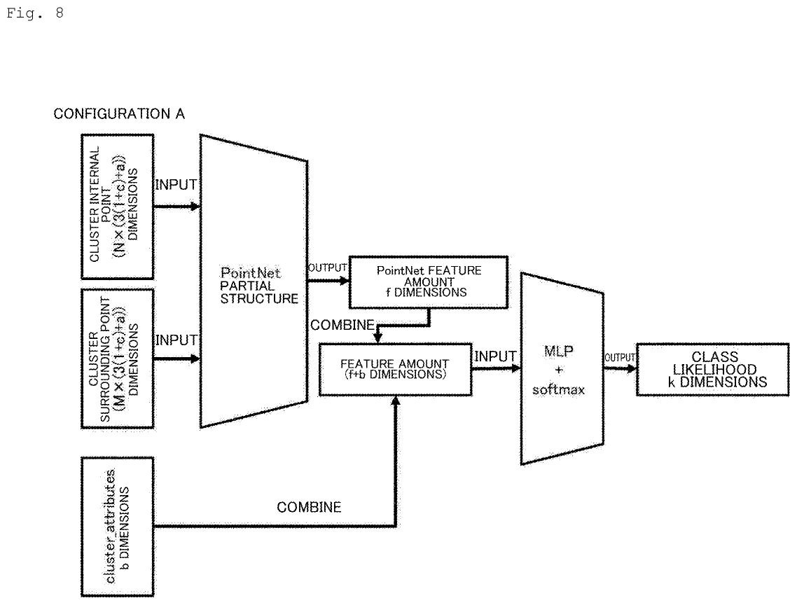

As shown in FIG. 8, in the configuration A, the cluster internal points (N points) and the cluster surrounding points (M points) are collectively input to the PointNet partial structure. As a result, as the output of the global feature extraction layer, an f-dimensional PointNet feature amount is obtained. f is a predetermined number. By combining the f-dimensional feature amount and b-dimensional (D4) cluster_attributes, an f+b-dimensional feature amount is obtained.

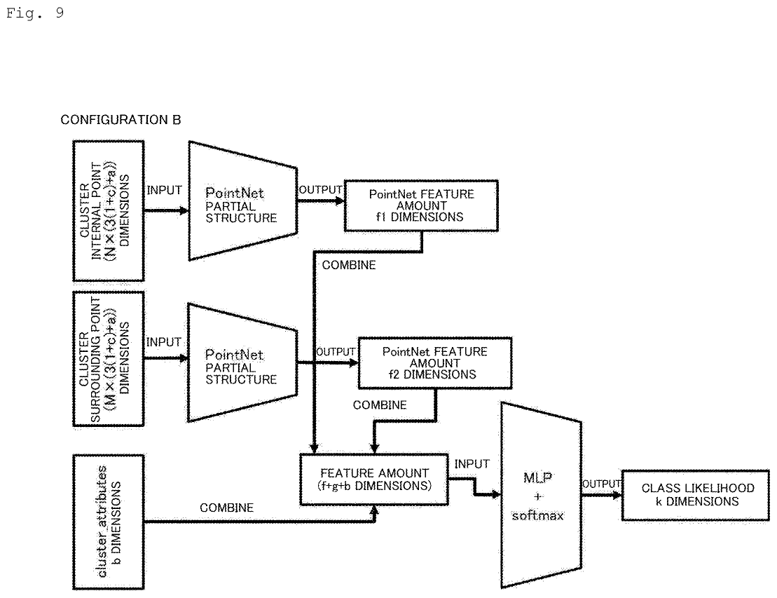

In addition, as shown in FIG. 9, in the configuration B, the cluster internal points (N points) and the cluster surrounding points (M points) are input to the PointNet partial structures separately. As a result, as the outputs of the global feature extraction layers, two PointNet feature amounts which are f1-dimensional and f2-dimensional PointNet feature amounts are obtained. f1 and f2 are predetermined numbers. Hereinafter, while f1+f2=f is satisfied for the sake of convenience, f herein does not need to be a value equal to f in the above-described configuration A. By combining the b-dimensional (D4) cluster_attributes and two PointNet feature amounts, i.e., the f1-dimensional and f2-dimensional PointNet feature amounts, a f1+f2+b=f+b-dimensional feature amount is extracted.

Note that (D2) positions is three-dimensional, (D3) point_attributes is a-dimensional, (D5) 3d_attributes is 3c-dimensional, and the number of cluster internal points is N, and hence the cluster internal point is N×(3(1+c)+a)-dimensional information. Similarly, the number of cluster surrounding points is M, and hence the cluster surrounding point is M×(3(1+c)+a)-dimensional information.

The learning unit 103 receives the f+b-dimensional feature amount obtained by using the PointNet partial structure of the configuration A or the configuration B described above as an input, processes the feature amount with mlp and softmax, and obtains a k-dimensional class likelihood. The learning unit 103 learns the DNN parameter by performing backpropagation on cross entropy between the k-dimensional class likelihood and a k-dimensional vector obtained by performing one hot encoding on the correct answer label derived for each cluster.

Note that, when data input to the DNN is performed, there are cases where the number of cluster internal points is larger than N, or the number of cluster surrounding points is larger than M. In these cases, the number thereof may be reduced by random sampling, and the data may be input. Conversely, there are cases where the number of cluster internal points is smaller than N, or the number of cluster surrounding points is smaller than M. In these cases, zero padding may be performed to cope with missing points, and the data may be input.

The learning unit 103 outputs the DNN parameter obtained as the result of the learning as a learned DNN parameter, and stores the learned DNN parameter in the learned DNN parameter storage unit 127.

The estimation unit 104 inputs the extended cluster data related to the cluster of which the label is unknown to the DNN of which the parameter is trained by the learning unit 103, and estimates the label of the cluster.

Specifically, the estimation unit 104 acquires the extended cluster data related to the target three-dimensional point cloud from the extended cluster data storage unit 124. In addition, the estimation unit 104 acquires the DNN hyperparameter from the DNN hyperparameter storage unit 126, and acquires the learned DNN parameter from the learned DNN parameter storage unit 127. In the estimation unit 104, the DNN structure used for outputting the learned DNN parameter is used. That is, the configuration A is used in the estimation unit 104 in the case where the configuration A is used in the learning unit 103, and the configuration B is used in the estimation unit 104 in the case where the configuration B is used in the learning unit 103.

Similarly to the learning unit 103, the estimation unit 104 inputs information on the cluster internal point and the cluster surrounding point included in the extended cluster data to the DNN. The information on the cluster internal point and the cluster surrounding point denotes (D2) positions, (D3) point_attributes, (D5) 3d_attributes, and (D4) cluster_attributes related to the cluster. The processing of the DNN is the same as that in the case of the learning unit 103.

The estimation unit 104 estimates, for each extended cluster data, e.g., the label of the class of which the value of the k-dimensional class likelihood is maximized in the k dimensions as the label of the cluster based on the k-dimensional class likelihood output by the DNN, and gives the label to the cluster. The estimation unit 104 outputs information on the target three-dimensional point cloud to which the label is given as an estimated label-given three-dimensional point cloud, and stores the estimated label-given three-dimensional point cloud in the estimated label-given three-dimensional point cloud storage unit 128.

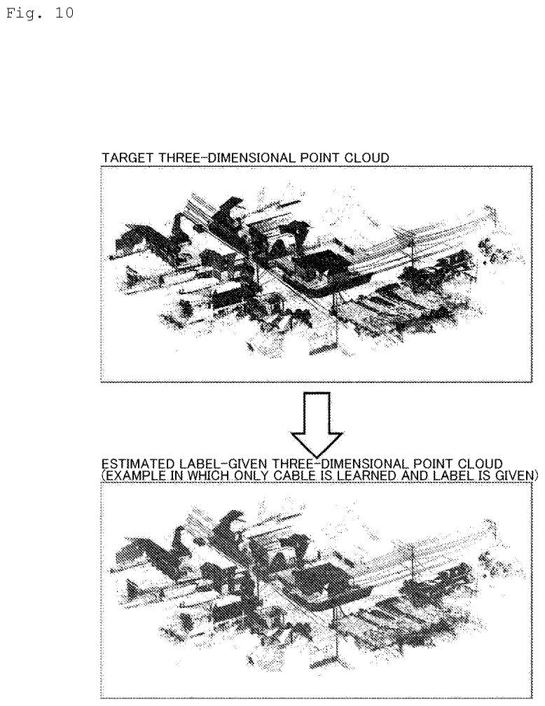

When the estimation unit 104 outputs the estimated label-given three-dimensional point cloud, the estimation unit 104 may output the label of each cluster without altering the label, or may also transform data to a point cloud form again by using information of (D1) center or (D2) positions and output the data. FIG. 10 shows an example of the estimated label-given three-dimensional point cloud. In the example in FIG. 10, a portion to which the label of a cable is given is represented by a shade which is lighter than those of other portions by the DNN having learned only the cable.

<Operation of Three-Dimensional Point Cloud Learning-Estimating Device>

Next, the operation of the three-dimensional point cloud label learning-estimating device 10 will be described.

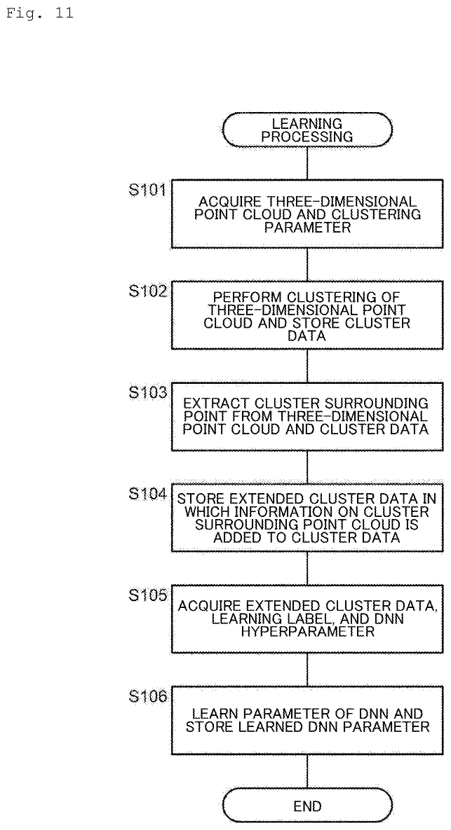

FIG. 11 is a flowchart showing the procedure of the learning processing by the three-dimensional point cloud label learning-estimating device 10. The CPU 11 reads the three-dimensional point cloud label learning program from the ROM 12 or the storage 14, loads the three-dimensional point cloud label learning program into the RAM 13, and executes the three-dimensional point cloud label learning program, and the learning processing is thereby performed.

In Step S101, the CPU 11, which serves as the clustering unit 101, acquires the information on the input three-dimensional point cloud from the three-dimensional point cloud storage unit 121, and acquires the clustering parameter from the clustering parameter storage unit 122.

Next, in Step S102, the CPU 11, which serves as the clustering unit 101, receives, as inputs, the acquired information on the input three-dimensional point cloud and the acquired clustering parameter, and divides the input three-dimensional point cloud into a plurality of clusters. Subsequently, the CPU 11, which serves as the clustering unit 101, outputs, for each cluster, the cluster data including the position coordinates and the attribute information of the cluster internal point and the attribute information obtained by the clustering processing, and stores the cluster data in the cluster data storage unit 123.

Next, in Step S103, the CPU 11, which serves as the surrounding point sampling unit 102, extracts the cluster surrounding point by searching the input three-dimensional point cloud for the three-dimensional point which is present within the distance r of the cluster internal point and is not included in the cluster.

Next, in Step S104, the CPU 11, which serves as the surrounding point sampling unit 102, outputs the extended cluster data in which the information on each extracted cluster surrounding point is added to the cluster data, and stores the extended cluster data in the extended cluster data storage unit 124.

Next, in Step S105, the CPU 11, which serves as the learning unit 103, acquires the extended cluster data from the extended cluster data storage unit 124, and acquires the learning label from the learning label storage unit 125. In addition, the CPU 11, which serves as the learning unit 103, acquires the DNN hyperparameter from the DNN hyperparameter storage unit 126.

Next, in Step S106, the CPU 11, which serves as the learning unit 103, derives the correct answer label of each cluster from the learning label. Subsequently, the CPU 11, which serves as the learning unit 103, receives the extended cluster data, the correct answer label of each cluster, and the DNN hyperparameter as inputs, and learns the DNN parameter. The CPU 11, which serves as the learning unit 103, stores the learned DNN parameter in the learned DNN parameter storage unit 127, and ends the learning processing.

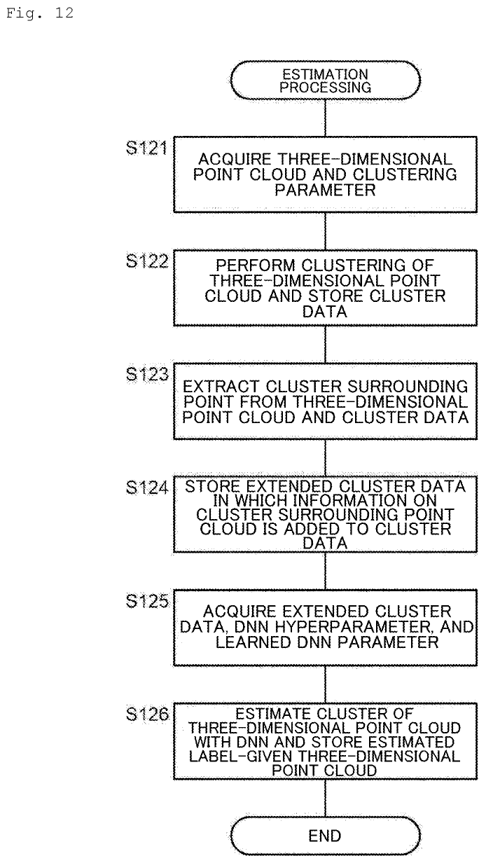

FIG. 12 is a flowchart showing the procedure of the estimation processing by the three-dimensional point cloud label learning-estimating device 10. The CPU 11 reads the three-dimensional point cloud label estimation program from the ROM 12 or the storage 14, loads the three-dimensional point cloud label estimation program into the RAM 13, and executes the three-dimensional point cloud label estimation program, and the estimation processing is thereby performed.

In Steps S121 to S124, the CPU 11 outputs and stores the extended cluster data for the target three-dimensional point cloud by the same processing as that in Steps S101 to S104 in the learning processing.

Next, in Step S125, the CPU 11, which serves as the estimation unit 104, acquires the extended cluster data related to the target three-dimensional point cloud from the extended cluster data storage unit 124. In addition, the CPU 11, which serves as the estimation unit 104, acquires the DNN hyperparameter from the DNN hyperparameter storage unit 126, and acquires the learned DNN parameter from the learned DNN parameter storage unit 127.

Next, in Step S126, the CPU 11, which serves as the estimation unit 104, inputs the information on the cluster internal point and the cluster surrounding point included in the extended cluster data to the DNN. Subsequently, the CPU 11, which serves as the estimation unit 104, estimates the label based on the output of the DNN for each extended cluster data, and gives the label to each cluster. Then, the CPU 11, which serves as the estimation unit 104, outputs the information on the target three-dimensional point cloud to which the label is given as the estimated label-given three-dimensional point cloud, and stores the estimated label-given three-dimensional point cloud in the estimated label-given three-dimensional point cloud storage unit 128. Subsequently, the estimation processing is ended.

As described thus far, the three-dimensional point cloud label learning-estimating device according to the present embodiment learns the parameter of the DNN by using the information on the three-dimensional point around the cluster in addition to the information on the three-dimensional point included in each cluster obtained by dividing the three-dimensional point cloud. With this, it becomes possible to give the label to the cluster in consideration of a surrounding environment in which the target cluster is positioned. Consequently, it is possible to perform the giving of the label to the three-dimensional point cloud representing a sweep shape structure with high accuracy.

Note that, while the three-dimensional cloud label learning-estimating device including both of the learning unit and the estimation unit has been described in the above embodiment, a three-dimensional point cloud label learning device which executes the learning processing and a three-dimensional point cloud label estimating device which executes the estimation processing may also be configured as separate apparatuses. In this case, as shown in FIG. 3, the three-dimensional point cloud label learning device may be appropriately configured as an apparatus including the individual elements other than the estimation unit 104 and the estimated label-given three-dimensional point cloud storage unit 128. In addition, as shown in FIG. 4, the three-dimensional point cloud label estimating device may be appropriately configured as an apparatus including the individual elements other than the learning unit 103 and the learning label storage unit 125.

Note that various processors other than the CPU may execute the learning processing and the estimation processing which the CPU has executed by reading software (program) in the above embodiment. Examples of the processor in this case include a PLD (Programmable Logic Device) having a circuit configuration which can be changed after manufacturing such as an FPGA (Field-Programmable Gate Array), and a dedicated electric circuit which is a processor having a circuit configuration designed exclusively for executing specific processing such as an ASIC (Application Specific Integrated Circuit). In addition, the learning processing and the estimation processing may be executed by one of the various processors, or may also be executed by a combination of two or more processors of the same type or different types (e.g., a combination of a plurality of FPGAs and a combination of a CPU and an FPGA). More specifically, the hardware structure of each of the various processors is an electric circuit in which circuit devices such as semiconductor devices are combined.

Further, while a mode in which the three-dimensional point cloud label learning program and the three-dimensional point cloud label estimation program are stored (installed) in advance in the ROM 12 or the storage 14 has been described in the above embodiment, the present invention is not limited thereto. The programs may also be stored in non-transitory storage media such as a CD-ROM (Compact Disc Read Only Memory), a DVD-ROM (Digital Versatile Disc Read Only Memory), and a USB (Universal Serial Bus) memory, and provided. In addition, the programs may also be downloaded from an external device via a network.

(Supplementary note 1)

A three-dimensional point cloud label learning device including: a memory; and

at least one processor connected to the memory, wherein

the processor divides an input three-dimensional point cloud into a plurality of clusters, extracts, for each of the plurality of clusters, a surrounding three-dimensional point cloud present within a predetermined distance of the cluster based on the three-dimensional point cloud and a result of cluster, and receives, as inputs, cluster information including information on a three-dimensional point cloud included in each cluster obtained by the division and information on the extracted surrounding three-dimensional point cloud and a label indicative of an object to which the three-dimensional point cloud included in each cluster belongs and learns a parameter of a deep neural net (DNN) for estimating the label of each cluster from the cluster information.

(Supplementary note 2)

A non-transitory recording medium storing a program which can be executed by a computer such that three-dimensional point cloud label learning processing is executed, the three-dimensional point cloud label learning processing including:

dividing an input three-dimensional point cloud into a plurality of clusters;

extracting, for each of the plurality of clusters, a surrounding three-dimensional point cloud present within a predetermined distance of the cluster based on the three-dimensional point cloud and a result of cluster; and receiving, as inputs, cluster information including information on a three-dimensional point cloud included in each cluster obtained by the division and information on the extracted surrounding three-dimensional point cloud and a label indicative of an object to which the three-dimensional point cloud included in each cluster belongs and learning a parameter of a deep neural net (DNN) for estimating the label of each cluster from the cluster information.

(Supplementary note 3)

A three-dimensional point cloud label estimating device including: a memory; and

at least one processor connected to the memory, wherein

the processor divides an input three-dimensional point cloud into a plurality of clusters, extracts, for each of the plurality of clusters, a surrounding three-dimensional point cloud present within a predetermined distance of the cluster based on the three-dimensional point cloud and a result of cluster, and inputs cluster information related to the cluster of which a label is unknown to a deep neural net (DNN) for estimating the label of each cluster from the cluster information which is trained by using, as inputs, the cluster information including information on a three-dimensional point cloud included in each cluster obtained by the division and information on the extracted surrounding three-dimensional point cloud, and the label indicative of an object to which the three-dimensional point cloud included in each cluster belongs to estimate the label of the cluster of which the label is unknown.

(Supplementary note 4)

A non-transitory recording medium storing a program which can be executed by a computer such that three-dimensional point cloud label estimation processing is executed, the three-dimensional point cloud label estimation processing including:

dividing an input three-dimensional point cloud into a plurality of clusters;

extracting, for each of the plurality of clusters, a surrounding three-dimensional point cloud present within a predetermined distance of the cluster based on the three-dimensional point cloud and a result of cluster; and

inputting cluster information related to the cluster of which a label is unknown to a deep neural net (DNN) for estimating the label of each cluster from the cluster information which is trained by using, as inputs, the cluster information including information on a three-dimensional point cloud included in each cluster obtained by the division and information on the extracted surrounding three-dimensional point cloud and the label indicative of an object to which the three-dimensional point cloud included in each cluster belongs to estimate the label of the cluster of which the label is unknown.

### REFERENCE SIGNS LIST

10 Three-dimensional point cloud label learning-estimating device
11 CPU
12 ROM
13 RAM
14 Storage
15 Input unit
16 Display unit
17 Communication I/F
19 Bus
101 Clustering unit
102 Surrounding point sampling unit
103 Learning unit
104 Estimation unit
120 Storage unit
121 Three-dimensional point cloud storage unit
122 Clustering parameter storage unit
123 Cluster data storage unit
124 Extended cluster data storage unit
125 Learning label storage unit
126 DNN hyperparameter storage unit
127 Learned DNN parameter storage unit
128 Estimated label-given three-dimensional point cloud storage unit

1. A three-dimensional point cloud label learning device comprising a processor configured to execute a method comprising:
dividing an input three-dimensional point cloud into a plurality of clusters;
extracting a surrounding three-dimensional point cloud present within a predetermined distance from a cluster of the plurality of clusters; and
receiving, as inputs, cluster information including information on a three-dimensional point cloud in the cluster and information on the surrounding three-dimensional point cloud, and a label indicative of an object to which the three-dimensional point cloud in the cluster belongs; and
learning a parameter of a deep neural network for estimating the label from the cluster information.

2. The three-dimensional point cloud label learning device according to claim 1, wherein,
in the deep neural network, the receiving further includes:
inputting the information on the three-dimensional point cloud in the cluster and the information on the surrounding three-dimensional point cloud collectively to a partial structure for extracting a feature amount of the input three-dimensional point cloud, and
extracting the feature amount.

3. The three-dimensional point cloud label learning device according to claim 1, wherein,
in the deep neural network, the learning further includes:
inputting information on the three-dimensional point cloud in the cluster to a first partial structure for extracting a feature amount of the input three-dimensional point cloud;
extracting a first feature amount, inputs the information on the surrounding three-dimensional point cloud to a second partial structure;
extracting a second feature amount; and
acquiring a feature amount, wherein the feature amount corresponds to a combination of the first feature amount and the second feature amount.

4. The three-dimensional point cloud label learning device according to claim 1, the processor further configured to execute a method comprising:
inputting the cluster information related to the cluster of which the label is unknown to the deep neural network of which the parameter is trained by the learning to estimate the label of the cluster of which the label is unknown.

5. A three-dimensional point cloud label estimating device comprising a processor configured to execute a method comprising:
dividing an input three-dimensional point cloud into a plurality of clusters;
extracting a surrounding three-dimensional point cloud present within a predetermined distance from a cluster of the plurality of clusters; and
inputting cluster information related to the cluster of which a label is unknown to a deep neural network for estimating the label of each cluster from the cluster information which is trained by using, as inputs, the cluster information and information on the surrounding three-dimensional point cloud, and the label indicative of an object to which a three-dimensional point cloud belongs to estimate the label of the cluster of which the label is unknown.

6. A three-dimensional point cloud label learning method comprising:
causing division an input three-dimensional point cloud into a plurality of clusters;
causing extraction of a cluster of the plurality of clusters, a surrounding three-dimensional point cloud present within a predetermined distance of the cluster; and
causing a receipt of, as inputs, cluster information including information on a three-dimensional point cloud in the cluster and information on the surrounding three-dimensional point cloud, and a label indicative of an object to which the three-dimensional point cloud included in each cluster belongs, and learn a parameter of a deep neural network for estimating the label of each cluster from the cluster information.

7-8. (canceled)

9. The three-dimensional point cloud label learning device according to claim 1, wherein the input three-dimensional point cloud indicates geometric information of an object, wherein a three-dimensional point cloud includes a three-dimensional point, and wherein the three-dimensional point includes three-dimensional position coordinates and at least an attribute information associated with the object.

10. The three-dimensional point cloud label learning device according to claim 1, wherein the object includes an artificial object with a structure in which a given cross-sectional shape is stretched.

11. The three-dimensional point cloud label learning device according to claim 2, the processor further configured to execute a method comprising:
inputting the cluster information related to the cluster of which the label is unknown to the deep neural network of which the parameter is trained by the learning to estimate the label of the cluster of which the label is unknown.

12. The three-dimensional point cloud label learning device according to claim 3, the processor further configured to execute a method comprising:
inputting the cluster information related to the cluster of which the label is unknown to the deep neural network of which the parameter is trained by the learning to estimate the label of the cluster of which the label is unknown.

13. The three-dimensional point cloud label estimating device according to claim 5,
in the deep neural network, the receiving further includes:
inputting the information on the three-dimensional point cloud in the cluster and the information on the surrounding three-dimensional point cloud collectively to a partial structure for extracting a feature amount of the input three-dimensional point cloud, and
extracting the feature amount.

14. The three-dimensional point cloud label estimating device according to claim 5, wherein,
in the deep neural network, the learning further includes:
inputting information on the three-dimensional point cloud in the cluster to a first partial structure for extracting a feature amount of the input three-dimensional point cloud;
extracting a first feature amount, inputs the information on the surrounding three-dimensional point cloud to a second partial structure;
extracting a second feature amount; and
acquiring a feature amount, wherein the feature amount corresponds to a combination of the first feature amount and the second feature amount.

15. The three-dimensional point cloud label estimating device according to claim 5, the processor further configured to execute a method comprising:
inputting the cluster information related to the cluster of which the label is unknown to the deep neural network of which the parameter is trained by the learning to estimate the label of the cluster of which the label is unknown.

16. The three-dimensional point cloud label estimating device according to claim 5, wherein the input three-dimensional point cloud indicates geometric information of an object, wherein a three-dimensional point cloud includes a three-dimensional point, and wherein the three-dimensional point includes three-dimensional position coordinates and at least an attribute information associated with the object.

17. The three-dimensional point cloud label estimating device according to claim 5, wherein the object includes an artificial object with a structure in which a given cross-sectional shape is stretched.

18. The three-dimensional point cloud label learning method according to claim 6, in the deep neural network, the receiving further includes:
inputting the information on the three-dimensional point cloud in the cluster and the information on the surrounding three-dimensional point cloud collectively to a partial structure for extracting a feature amount of the input three-dimensional point cloud, and
extracting the feature amount.

19. The three-dimensional point cloud label learning method according to claim 6, wherein,
in the deep neural network, the learning further includes:
inputting information on the three-dimensional point cloud in the cluster to a first partial structure for extracting a feature amount of the input three-dimensional point cloud;
extracting a first feature amount, inputs the information on the surrounding three-dimensional point cloud to a second partial structure;
extracting a second feature amount; and
acquiring a feature amount, wherein the feature amount corresponds to a combination of the first feature amount and the second feature amount.

20. The three-dimensional point cloud label learning method according to claim 6, the processor further configured to execute a method comprising:
inputting the cluster information related to the cluster of which the label is unknown to the deep neural network of which the parameter is trained by the learning to estimate the label of the cluster of which the label is unknown.

21. The three-dimensional point cloud label learning method according to claim 6, wherein the input three-dimensional point cloud indicates geometric information of an object, wherein a three-dimensional point cloud includes a three-dimensional point, and wherein the three-dimensional point includes three-dimensional position coordinates and at least an attribute information associated with the object.

22. The three-dimensional point cloud label learning method according to claim 6, wherein the object includes an artificial object with a structure in which a given cross-sectional shape is stretched.
